(19) United States
(12) Patent Application Publication
(10) Pub. No.: US 2012/0218542 A1
(43) Pub. Date: Aug. 30, 2012

(54) INFRARED ANALYSIS APPARATUS

(75) Inventors: Yasushi ICHIZAWA, Tokyo (JP); Kumiko Horikoshi, Tokyo (JP); Atsushi Tsujii, Tokyo (JP); Shigeyuki Kakuta, Tokyo (JP)

(73) Assignee: Yokogawa Electric Corporation, Tokyo (JP)

(21) Appl. No.: 13/402,599

(22) Filed: Feb. 22, 2012

(30) Foreign Application Priority Data
Feb. 24, 2011 (JP) 2011-038246

(51) Int. Cl. G01N 21/59

(52) U.S. Cl. 356/51

(57) ABSTRACT

An infrared analysis apparatus may include a first head and a second head. The first head may include a plurality of light sources each of which irradiates rays of infrared light having different wavelengths on a test object, and an optical element that is disposed between the plurality of light sources and the test object, the optical element making intensity distribution of the infrared light uniform. The second head may include a detector that detects the infrared light transmitted through the test object.

### BACKGROUND OF THE INVENTION

1. Field of the Invention

The present invention relates to an infrared analysis apparatus that analyzes properties of a test object using infrared light.

Priority is claimed on Japanese Patent Application No. 2011-038246, filed Feb. 24, 2011, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

An infrared analysis apparatus is an apparatus that tests a test object by irradiating infrared light on the test object, receiving the infrared light transmitted through the test object or reflected and scattered by the test object, and obtaining transmission or reflection characteristics. The infrared analysis apparatus is used in a variety of fields, because it can test the characteristics of the test object without destroying the test object. For example, in the paper manufacturing field, a moisture meter that performs on-line measurement on moisture contained in the paper that is a product or a paper thickness meter that performs on-line measurement on the thickness of the paper is used.

In detail, both the moisture meter and the paper thickness meter irradiate a plurality of rays of near-infrared light having different wavelengths on the test object, receives the rays of near-infrared light transmitted through the paper, obtains the absorptance of each ray of near-infrared light, and measures the moisture or thickness of the paper with reference to a relationship between the absorptances of the near-infrared light and the moisture or thickness of the paper, both of which have been previously measured. As the near-infrared light irradiated on the paper, for example, near-infrared light having a wavelength of 1.94 μm at which the absorptance by water is high, near-infrared light having a wavelength of 2.1 μm at which the absorptance by cellulose, which is a component occupying 80% of paper, is high, and near-infrared light having a wavelength of 1.7 μm at which the absorptance by water and the absorptance by cellulose are both low are used.

Conventionally, a lamp such as a halogen lamp has been used as a light source for the near-infrared light. However, recently, opportunities to use semiconductor light-emitting elements such as laser diodes (LDs) or light-emitting diodes (LEDs) have increased. The semiconductor light-emitting elements such as the LDs or the LEDs have advantages such as long service life, high light-emitting efficiency, low power consumption, and easy modulation. A sensor measuring moisture in a sheet product such as paper using an LD or an LED as a light source is disclosed in Japanese Unexamined Patent Application, First Publication No. 2008-539422.

However, the infrared analysis apparatus such as the moisture meter or the paper thickness meter measures the moisture or the thickness of the paper using the plurality of rays of near-infrared light having different wavelengths. As such, when the semiconductor light-emitting element such as the LD or the LED is used as the light source, a plurality of semiconductor light-emitting elements emitting the rays of near-infrared light having the respective wavelengths are required. In the infrared analysis apparatus having the plurality of semiconductor light-emitting elements, for maintaining the precision of measurement, it is important that the intensity distribution of the rays of near-infrared light having the respective wavelengths irradiated on the test object be spatially uniform and made complete.

This is because, when the spatial intensity distribution of the rays of near-infrared light having the respective wavelengths irradiated on the paper serving as the test object is non-uniform and thus is not made complete, a relative positional offset between the semiconductor light-emitting element and a light-receiving element occurs, and in this case, the intensity of the near-infrared light received by the light-receiving element is changed depending on an amount of the positional offset, and the precision of measurement becomes worse. Further, another reason is that, when the paper is vibrated by fluctuation of feed tension, and thus a passage position of the paper between the semiconductor light-emitting element and the light-receiving element is changed, the precision of measurement similarly becomes worse.

Here, since the semiconductor light-emitting element makes the intensity distribution of the emitted near-infrared light uniform, the semiconductor light-emitting element is frequently combined with a light collection optical system such as a parabolic mirror or an oval mirror when used. As a method of combining the semiconductor light-emitting element with the light collection optical system, a method of combining one semiconductor light-emitting element with one light collection optical system, or a method of combining a plurality of semiconductor light-emitting elements with one light collection optical system is considered. The former method causes rays of near-infrared light emerging from the light collection optical system to overlap at the same position on the test object. However, despite the occurrence of overlapping, the intensity distribution is not made uniform. The latter method causes a diameter (spot diameter) of each ray of near-infrared light that emerges from the light collection optical system and is irradiated on the test object to be different at each wavelength, so that the intensity distribution is not made uniform.

### SUMMARY

An object of the present invention is to provide an infrared analysis apparatus capable of maintaining high precision of measurement by making intensity distribution uniform without increasing a spot diameter of infrared light emitted from each semiconductor light-emitting element more than necessary.

An infrared analysis apparatus may include a first head and a second head. The first head may include a plurality of light sources each of which irradiates rays of infrared light having different wavelengths on a test object, and an optical element that is disposed between the plurality of light sources and the test object, the optical element making intensity distribution of the infrared light uniform. The second head may include a detector that detects the infrared light transmitted through the test object.

The optical element may multi-reflect each infrared light to cause the intensity distribution of the infrared light to be uniform and to cause the infrared light irradiated on the test object. The optical element may have a polyhedral shape.

The optical element may include an incident end on which the infrared light from the light sources is incident, and an emergent end from which the multi-reflected infrared light emerges. The optical element may have a tapered shape in which the emergent end is larger than the incident end.

The plurality of light sources may be arranged in a matrix array within a plane in line with the incident end of the optical element.

The optical element may be a polygonal ring-shaped internal reflector in which an inner surface thereof serves as a reflective surface reflecting the infrared light emitted from the plurality of light sources.

The optical element may be an internal reflector in which a glass material transparent to the infrared light is formed in a polygonal column shape and each face serves as a reflective surface.

The first head may further include a light collection optical system that is disposed between the optical element and the test object and collect the infrared light emerging from the optical element on the test object.

An infrared analysis apparatus may include a first head, a second head, and a frame. The first head may include a plurality of light sources each of which irradiating rays of infrared light having different wavelengths on a test object, and an optical element that is disposed between the plurality of light sources and the test object, the optical element making intensity distribution of the infrared light uniform. The second head may include detector that detects the infrared light transmitted through the test object. The test object may be sandwiched between the first and the second head in a middle of an opening of the frame. The frame may have a quadrangular ring shape having a longitudinal direction and a transverse direction. The frame may include a first mechanism reciprocating the first head along the test object in the longitudinal direction, and a second mechanism reciprocating the second head along the test object in the longitudinal direction.

The optical element may multi-reflect the infrared light to cause the intensity distribution of the infrared light to be uniform, and causes the infrared light irradiated on the test object. The optical element may have a polyhedral shape.

The optical element may include an incident end that has a quadrangular shape and on which the infrared light emitted from the plurality of light sources is incident, and an emergent end that has a shape similar to that of the incident end and from which the infrared light undergoing multi-reflection emerges.

The optical element may have a tapered shape in which the emergent end is formed so as to be larger than the incident end.

The incident end may be disposed so as to be close to the plurality of light sources.

The first head may further include a light collection optical system that is disposed between the optical element and the test object and collects the infrared light emerging from the optical element on the test object.

The plurality of light sources may be arranged in a matrix array within a plane in line with the incident end of the optical element.

The optical element may be a polygonal ring-shaped internal reflector in which an inner surface thereof serves as a reflective surface reflecting the infrared light emitted from the plurality of light sources.

The optical element may be an internal reflector in which a glass material transparent to the infrared light is formed in a polygonal column shape and each face serves as a reflective surface.

An infrared analysis method may include irradiating a plurality of rays of infrared light having different wavelengths on a test object, multi-reflecting the plurality of rays of infrared light to cause intensity distribution of the infrared light irradiated on the test object to be uniform, and detecting the rays of infrared light transmitted through the test object.

The infrared analysis method may further include collecting the plurality of rays of infrared light on the test object.

According to the present invention, the rays of infrared light having different wavelengths emitted from a plurality of light sources disposed on one side of a test object are incident on a polygonal optical element, and are multi-reflected. Thereby, the intensity distribution is made uniform. The rays of infrared light whose intensity distribution is made uniform emerge from the optical element, and then are irradiated on the test object. Among the rays of infrared light irradiated on the test object, some transmitted through the test object are detected by a detector. As such, the intensity distribution can be made uniform without increasing the spot diameter of the infrared light more than necessary. Thereby, high precision of measurement can be maintained.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a perspective view illustrating a schematic configuration of a moisture meter as an infrared analysis apparatus in accordance with a first preferred embodiment of the present invention;

FIG. 2 is a front perspective view illustrating internal configurations of the upper head and the lower head with which the moisture meter is equipped;

FIGS. 3A and 3B are perspective views illustrating a specific example of the configuration of the light pipe with which the moisture meter is equipped;

FIG. 4 is a view illustrating an internal configuration of a first head of a moisture meter in accordance with a first modification; and

FIG. 5 is a view illustrating semiconductor light-emitting elements of a moisture meter in accordance with a second modification.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An infrared analysis apparatus in accordance with a first preferred embodiment of the present invention will be described below with reference to the drawings. Further, to facilitate understanding, the following description will be made regarding the case in which the present invention is applied to a moisture meter that is a type of infrared analysis apparatus by way of example. However, the present invention may also be applied to other infrared analysis apparatuses such as a paper thickness meter in the same way as it is to the moisture meter.

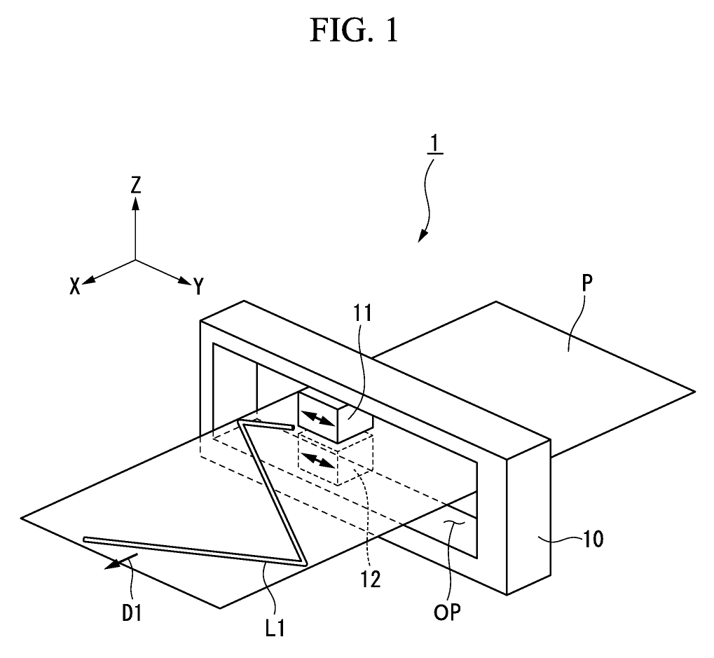

FIG. 1 is a perspective view illustrating a schematic configuration of a moisture meter as an infrared analysis apparatus in accordance with a first preferred embodiment of the present invention. As shown in FIG. 1, a moisture meter 1 includes a frame 10, an upper head 11 (first head), and a lower head 12 (second head), is attached to, for example, a paper machine installed on a paper mill, and measures moisture contained in paper P (test object) manufactured by the paper machine.

Further, in the following description, a positional relationship between members will be described with reference to, if necessary, an XYZ Cartesian coordinate system set in the drawings. However, for convenience of the description, the origin of the XYZ Cartesian coordinate system shall be arbitrarily changed in each drawing without being fixed. In the XYZ Cartesian coordinate system shown in FIG. 1, the X axis is the direction going along a feed direction D1 of the paper P, the Y axis is the direction going along a widthwise direction of the paper P, and the Z axis is the direction going along a vertical direction.

The frame 10 is a substantially quadrangular ring-shaped member in which an external geometry has a longitudinal direction and a transverse direction. An opening OP of the frame is configured so that the upper head 11 and the lower head 12 are supported therein so as to enable a reciprocating motion in the longitudinal direction. In detail, the frame 10 is disposed so that the longitudinal direction thereof is the direction going along the widthwise direction (Y direction) of the paper P, the transverse direction thereof is the direction going along the vertical direction (Z direction) of the paper P, and the paper P passes through the substantial middle of the opening OP.

That is, the frame 10 is positioned relative to the paper P so that the upper head 11 is disposed above the fed paper P and the lower head 12 is disposed below the fed paper P. Further, although not shown in FIG. 1, the frame 10 is equipped with a mechanism that reciprocates the upper head 11 along a top surface of the paper P in the longitudinal direction of the frame and a mechanism that reciprocates the lower head 12 along a bottom surface of the paper P in the longitudinal direction of the frame. When these mechanisms are driven in the same way, the upper head 11 and the lower head 12 can be synchronized and reciprocated. When these mechanisms are driven independently, the upper head 11 and the lower head 12 can be individually moved. As described above, the upper head 11 is supported on the frame 10 so as to be able to be reciprocated along the top surface of the paper P in the widthwise direction of the paper P, and irradiates a plurality of rays of infrared light (near-infrared light) having different wavelengths toward the top surface of the paper P. In detail, near-infrared light having a wavelength λ1 (e.g., 1.94 nm) at which the absorptance by water is high, near-infrared light having a wavelength λ2 (e.g., 2.1 nm) at which the absorptance by cellulose, which is a component occupying 80% of paper, is high, and near-infrared light having a wavelength λ3 (e.g., 1.7 μm) at which the absorptance by water and the absorptance by cellulose are both low are irradiated onto the top surface of the paper P.

As described above, the lower head 11 is supported on the frame 10 so as to be able to be reciprocated along the bottom surface of the paper P in the widthwise direction of the paper P, and receives the near-infrared light via the paper P. Moisture contained in the paper P is measured based on a detected result of the near-infrared light received by the lower head 11. Further, the upper head 11 and the lower head 12 are synchronized and reciprocated in the widthwise direction (Y direction) of the paper P with the paper P fed in the feed direction D1 (X direction) sandwiched therebetween. Thereby, the moisture contained in the paper P is measured along a measurement line L1 in a zigzag pattern shown in FIG. 1.

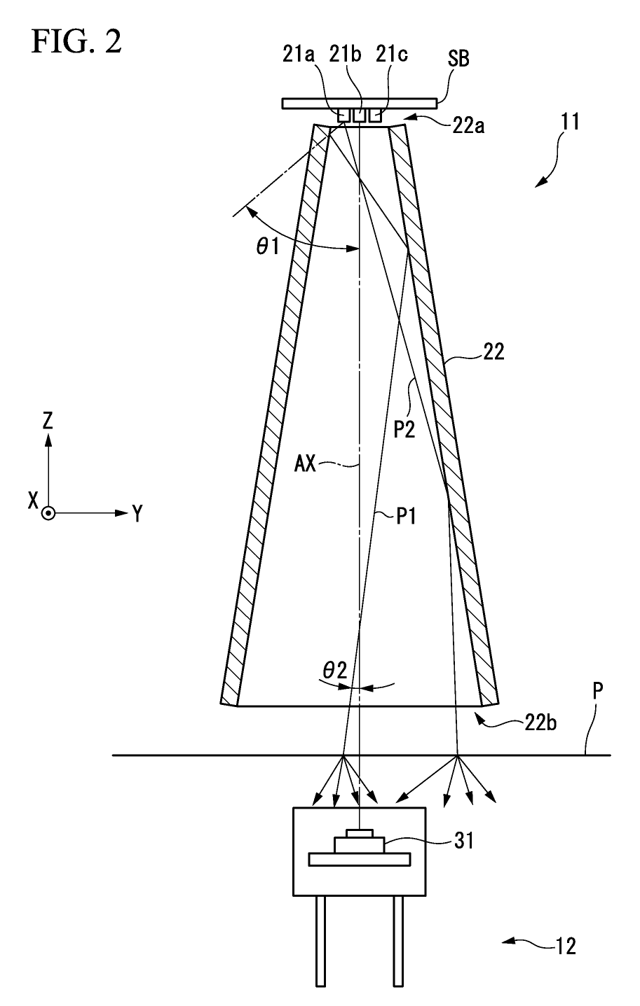

Next, internal configurations of the upper and lower heads 11 and 12 will be described in detail. FIG. 2 is a front perspective view illustrating internal configurations of the upper head and the lower head with which the moisture meter is equipped. Further, in FIG. 2, housings of the upper and lower heads 11 and 12 are not shown, and the upper head 11 is shown in a fragmentary sectional view. As shown in FIG. 2, the upper head 11 includes semiconductor light-emitting elements 21a to 21c (a plurality of light sources) and a light pipe (optical element) 22.

The semiconductor light-emitting elements 21a to 21c are, for example, laser diodes (LDs) or light-emitting diodes (LEDs), and emit the near-infrared light to be irradiated onto the paper P. In detail, the semiconductor light-emitting element 21a emits near-infrared light having a wavelength λ1 (e.g., 1.94 μm) at which the absorptance by water is high, the semiconductor light-emitting element 21b emits near-infrared light having a wavelength λ2 (e.g., 2.1 μm) at which the absorptance by cellulose is high, and the semiconductor light-emitting element 21c emits near-infrared light having a wavelength λ3 (e.g., 1.7 μm) at which both the absorptance by water and the absorptance by cellulose are low. The semiconductor light-emitting elements 21a to 21c are mounted on a mounting board SB having a flat plate shape such as a printed circuit board or a ceramic substrate at regular intervals in arrangement of a linear or planar shape.

The light pipe 22 is a polygonal optical element that is disposed between the semiconductor light-emitting elements 21a to 21c and the paper P and causes intensity distribution to be uniform by multi-reflecting the near-infrared light emitted from each of the semiconductor light-emitting elements 21a to 21c. In detail, the light pipe 22 includes an incident end 22a which has a quadrangular shape on an XY plane and on which the near-infrared light emitted from each of the semiconductor light-emitting elements 21a to 21c is incident, and an emergent end 22b which has a shape similar to the incident end 22a on the XY plane and from which the multi-reflected near-infrared light emerges, and is a tapered optical element in which the emergent end 22b is formed so as to be greater than the incident end 22a.

In detail, the light pipe 22 is configured such that, for example, one side of the incident end 22a has a length of several millimeters, and one side of the emergent end 22b has a length of tens of millimeters to several tens of millimeters. Here, a spot diameter of the near-infrared light emerging from the light pipe 22 is set to be as large as a measurement region set on the paper P and is determined depending on the size of the emergent end 22b. As such, the size of the emergent end 22b is set so as to be as large as the measurement region set on the paper P. Further, the light pipe 22 is disposed between the semiconductor light-emitting elements 21a to 21c and the paper P so that the semiconductor light-emitting elements 21a to 21c mounted on the mounting board SB approach the incident end 22a as closely as possible, and so that an interval between the light pipe and the paper P becomes several millimeters.

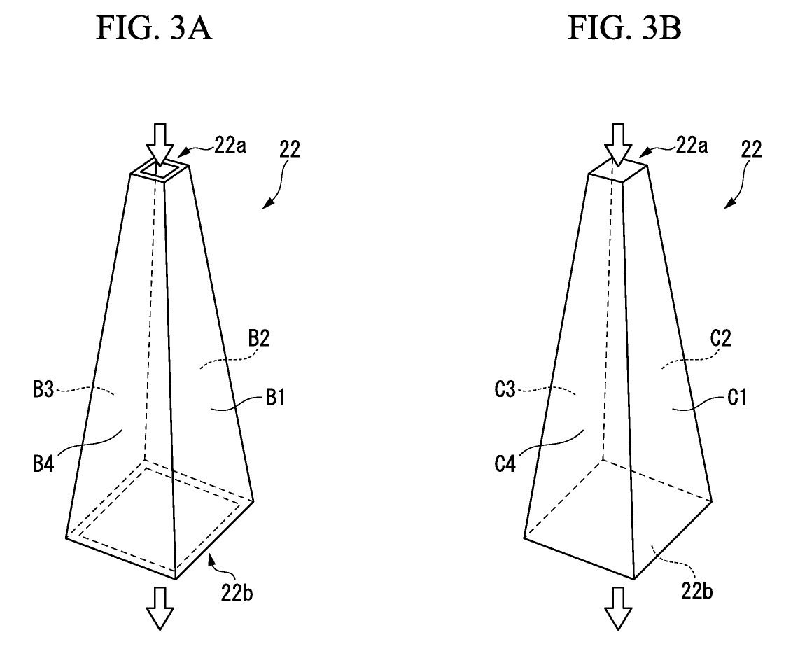

FIGS. 3A and 3B are perspective views illustrating a specific example of the configuration of the light pipe with which the moisture meter is equipped. The light pipe 22 shown in FIG. 3A is an internal reflector having a quadrangular ring shape (hollow quadrangular cone shape) formed by bonding trapezoidal planar members B1 to B4 together, whereas the light pipe 22 shown in FIG. 3B is an internal reflector that is formed of a transparent glass material in a tetragonal frustum shape (quadrangular cone shape) for the near-infrared light emerging from the semiconductor light-emitting elements 21a to 21c. Note that, in FIG. 2, the light pipe 22 shown in FIG. 3A is shown. The light pipe 22 shown in FIG. 3A is formed by bonding oblique sides of the planar members B1 to B4, each of which is formed of a metal plate such as an aluminum plate having high reflectance (e.g., 90% or more) to the near-infrared light emerging from the semiconductor light-emitting elements 21a to 21c. Alternatively, the light pipe 22 shown in FIG. 3A is formed by bonding oblique sides of the planar members B1 to B4, each of which is formed of a metal plate or a glass plate whose reflectance to the near-infrared light emerging from the semiconductor light-emitting elements 21a to 21c is increased (e.g. to 90% or more) by depositing one surface thereof with gold or silver, with the deposited surface directed to the inside.

Further, the light pipe 22 shown in FIG. 3A may be formed using a method other than the method of bonding the four planar members B1 to B4 together. For example, the light pipe 22 shown in FIG. 3A may be formed by cutting an interior of a metal block whose external geometry has a quadrangular cone shape in a quadrangular ring shape as shown in FIG. 3A, and treating (e.g. mirror-treating) the cut inner surface so that the reflectance to the near-infrared light emerging from the semiconductor light-emitting elements 21a to 21c becomes high.

The light pipe 22 shown in FIG. 3B is formed in a tetragonal frustum shape (quadrangular cone shape) by grinding a glass material, such as sapphire (Al₂O₃), calcium fluoride (CaF₂), BK7, or crown glass, which is transparent to the near-infrared light emerging from the semiconductor light-emitting elements 21a to 21c and has a low refractive index of about 1.5 with respect to the near-infrared light. Further, when BK7 or crown glass is used as the glass material, the light pipe can be formed at a low cost, compared to the case in which sapphire or calcium fluoride is used as the glass material.

Here, since the light pipe 22 shown in FIG. 3A reflects the near-infrared light, which is emitted from the semiconductor light-emitting elements 21a to 21c and travels in the air, on the inner surface thereof, the near-infrared light is considered to be attenuated by several % when reflected. In contrast, since the light pipe 22 shown in FIG. 3B reflects the near-infrared light, which is emitted from the semiconductor light-emitting elements 21a to 21c and travels through the interior of the glass material of which the light pipe 22 is formed, on faces C1 to C4 thereof, the near-infrared light can be totally reflected. Accordingly, in terms of attenuation of the case in which the near-infrared light is multi-reflected, the light pipe 22 shown in FIG. 3B is considered to be favorable.

Further, since the light pipe 22 shown in FIG. 3A has the quadrangular ring shape, no reflection occurs when the near-infrared light is incident on the incident end 22a and when the incident near-infrared light emerges from the emergent end 22b. In contrast, since the light pipe 22 shown in FIG. 3B is formed of the glass material in the tetragonal frustum shape (quadrangular cone shape), reflection occurs when the near-infrared light is incident on the incident end 22a and when the incident near-infrared light emerges from the emergent end 22b. However, since the light pipe 22 shown in FIG. 3B uses the glass material whose refractive index is low with respect to the near-infrared light such as BK7 or crown glass, the reflection occurring at the incident end 22a and the emergent end 22b can be suppressed to be low.

Returning to FIG. 2, the light pipe 22 makes the intensity distribution uniform by multi-reflecting the near-infrared light emitted from each of the semiconductor light-emitting elements 21a to 21c. Now, as shown in FIG. 2, the near-infrared light, which is emitted from the semiconductor light-emitting element 21a disposed at a position deviating from an optical axis AX in line with a central axis of the light pipe 22 and passes through paths P1 and P2, is taken into consideration. The near-infrared light passing through the path P1 is emitted from the semiconductor light-emitting element 21a at an angle of θ1 relative to the optical axis AX, and travels from the incident end 22a into the light pipe 22. Thus, the near-infrared light passing through the path P1 emerges from the emergent end 22b in such a way that the angle relative to the optical axis AX gradually becomes small whenever the reflection occurs twice on the inner surface of the light pipe 22 and finally becomes an angle of θ₂ (θ1>θ2). Similarly, the near-infrared light passing through the path P2 also emerges from the emergent end 22b in such a way that the angle relative to the optical axis AX becomes small by reflection once on the inner surface of the light pipe 22.

In this way, the near-infrared light, which travels from the incident end 22a into the light pipe 22, is gradually reduced in the angle relative to the optical axis AX by the reflection (multi-reflection) on the inner surface of the light pipe 22, and emerges from the emergent end 22b. As such, even when the angle relative to the optical axis AX when the near-infrared light is incident on the incident end 22a (the angle of the near-infrared light emitted from the semiconductor light-emitting elements 21a to 21c) becomes different, the near-infrared light emerges from the light pipe 22 approximately in parallel to the optical axis AX. For this reason, the near-infrared light having uniform intensity distribution can be irradiated on the top surface of the paper P without increasing the spot diameter more than necessary.

As shown in FIG. 2, the lower head 12 is equipped with a detector 31. The detector 31 is disposed below the paper P so that a light-receiving surface thereof is located on an extension line of the optical axis AX and the interval between the light-receiving surface and the paper P becomes several millimeters, and detects the near-infrared light through the paper P (i.e. the near-infrared light transmitted from the top surface to the bottom surface of the paper P). As the detector 31, for example, a PbS element, a Ge element, or an InGaAs element may be used.

Here, the PbS element is a photoconductive element that essentially consists of lead sulfide, can detect light having a wavelength range of about 0.6 to 3.0 μm, and is an element having maximum sensitivity of detection in the vicinity of a wavelength of 2.0 μm. The Ge element is a photoconductive element that essentially consists of germanium, and is an element that can detect light having a wavelength range of about 0.6 to 1.8 μm. The InGaAs element is a ternary mixed crystal semiconductor element that essentially consists of indium, gallium and arsenic, and is an element that is able to detect light having a wavelength range of about 0.9 to 2.3 μm and has maximum sensitivity of detection in the vicinity of a wavelength of 1.5 to 1.8 μm.

Next, an operation of the moisture meter 1 having the above configuration will be described. When the operation of the moisture meter 1 is initiated, the upper head 11 and the lower head 12 are driven by a mechanism (not shown) installed on the frame 10. The upper head 11 and the lower head 12 are synchronized and reciprocated in the widthwise direction (Y direction) of the paper P. At the same time that the upper head 11 and the lower head 12 begin to be driven, the semiconductor light-emitting elements 21a to 21c installed on the upper head 11 also begin to be driven. Thereby, the near-infrared light having a wavelength of λ1 (e.g., 1.94 μm) is emitted from the semiconductor light-emitting element 21a, the near-infrared light having a wavelength of λ2 (e.g., 2.1 μm) is emitted from the semiconductor light-emitting element 21b, and the near-infrared light having a wavelength of λ3 (e.g., 1.7 μm) is emitted from the semiconductor light-emitting element 21c.

The near-infrared light emitted from each of the semiconductor light-emitting elements 21a to 21c travels from the incident end 22a into the light pipe 22, is gradually reduced in the angle relative to the optical axis AX by multi-reflection on the interior of the light pipe 22, is subjected to uniform intensity distribution, emerges from the emergent end 22b, and then is irradiated on the top surface of the paper P. Part of the near-infrared light irradiated on the top surface of the paper P is reflected and scattered on the top surface of the paper P, and the rest is transmitted through the paper P.

The near-infrared light transmitted through the paper P is detected by the detector 31 installed on the lower head 12. Here, the near-infrared light having the wavelength of λ1 is absorbed by moisture contained in the paper P when transmitted through the paper P, and the near-infrared light having the wavelength of λ2 is absorbed by cellulose that is a component of the paper P when transmitted through the paper P. In contrast, the near-infrared light having the wavelength of λ3 is only slightly absorbed even when transmitted through the paper P. As such, an intensity of the near-infrared light having the wavelength of λ1 or λ2 becomes smaller, compared to that of the near-infrared light having wavelength of λ3.

When the near-infrared light is detected by the detector 31, the detected signal is amplified and then split, so that measurement signals S1, S2 and S3 corresponding to the rays of near-infrared light having wavelengths of λ1, λ2 and λ3 are obtained. Then, an absorptance of the near-infrared light is obtained by multivariate analysis based on a ratio of the measurement signals. When the absorptance of the near-infrared light is obtained, the moisture contained in the paper P is measured with reference to, for example, a table that shows a relation between the absorptance of the near-infrared light and the moisture of the paper P, both of which have been measured in advance. The measurement of the moisture may be performed using a previously set relation other than the method of using the table.

The measurement above continues to be performed while the upper head 11 and the lower head 12 are being synchronized and reciprocated in the widthwise direction (Y direction) of the paper P, with the paper P fed in the feed direction D1 (X direction) shown in FIG. 1. Accordingly, the moisture contained in the paper P is measured along the measurement line L1 having the zigzag pattern shown in FIG. 1.

As described above, in the first preferred embodiment, the light pipe 22 having the quadrangular ring shape (hollow quadrangular cone shape) or the tetragonal frustum shape (quadrangular cone shape) is installed between the plurality of semiconductor light-emitting elements 21a to 21c, each of which emits the near-infrared light having a different wavelength, and the paper P that is the test object, and the near-infrared light emitted from each of the semiconductor light-emitting elements 21a to 21c is multi-reflected to undergo the uniform intensity distribution. As such, the intensity distribution can be made uniform without increasing the spot diameter of the near-infrared light emitted from the semiconductor light-emitting elements 21a to 21c more than necessary. Thereby, for example, even when a relative positional offset between the upper head 11 and the lower head 12 or an offset in passage position of the Z direction of the paper P in the opening OP of the frame 10 occurs, high precision of measurement can be maintained.

Further, in the first preferred embodiment, since the light pipe 22 is disposed so that the incident end 22a approaches the semiconductor light-emitting elements 21a to 21c mounted on the mounting board SB as close as possible, the near-infrared light emitted from the semiconductor light-emitting elements 21a to 21c can be collected and put into effective use without waste. Furthermore, since the length of the light pipe 22 is good to set in consideration of desired precision of measurement, the light pipe can be reduced in size. Moreover, the light pipe can be made without incurring a remarkable increase in cost.

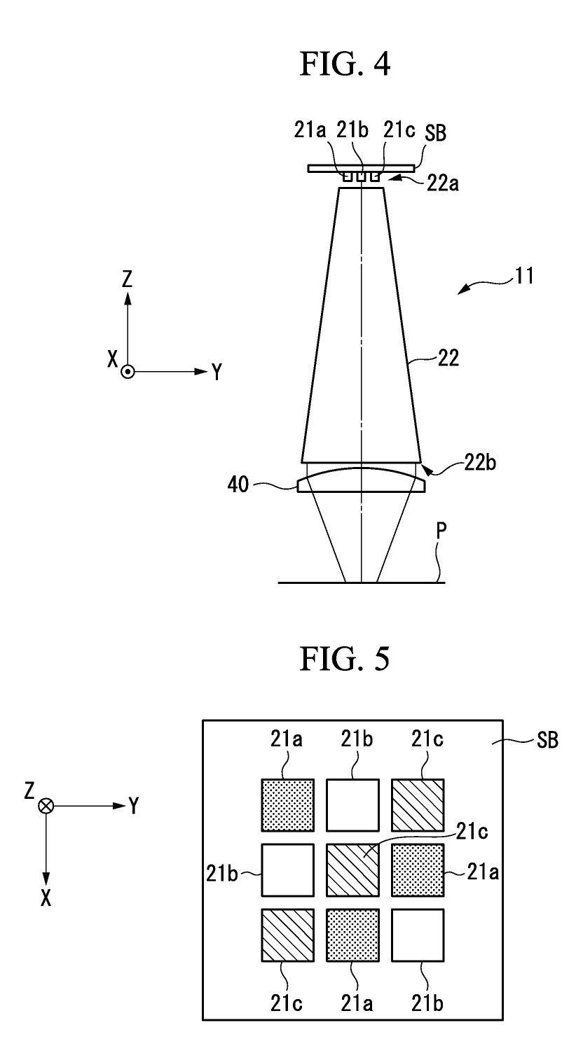

Next, a modification of the first preferred embodiment will be described. FIG. 4 is a view illustrating an internal configuration of a first head of a moisture meter in accordance with a first modification. In FIG. 4, the same members as those shown in FIG. 2 are given the same symbols. As shown in FIG. 4, the first head 11 of the moisture meter in accordance with the first modification is configured so that a plano-convex lens (light collection optical system) 40 is disposed between a light pipe 22 and paper P. The plano-convex lens 40 collects near-infrared light emerging from an emergent end 22b of the light pipe 22 on the paper P.

In the first preferred embodiment described above, since the size of the emergent end 22b of the light pipe 22 is set to be as large as that of the measurement region set on the paper P, the light pipe 22 may only be disposed so as to direct the emergent end 22b toward the paper P. However, when an interval between the light pipe 22 and the paper P is intended to be enlarged, or when a spot diameter is reduced to increase the sensitivity of detection, as shown in FIG. 4, the plano-convex lens 40 may be disposed between the light pipe 22 and the paper P, and may collect the near-infrared light emerging from an emergent end 22b of the light pipe 22 on the paper P.

FIG. 5 is a view illustrating semiconductor light-emitting elements of a moisture meter in accordance with a second modification. In FIG. 5, the same members as those shown in FIG. 2 are also given the same symbols. As shown in FIG. 5, the moisture meter in accordance with the second modification is configured so that a plurality of semiconductor light-emitting elements 21a to 21c are arranged on a mounting board SB in a matrix array. In detail, in an example shown in FIG. 5, the semiconductor light-emitting elements 21a to 21c are mounted on the mounting board SB in threes. Further, since the mounting board SB is disposed so as to be parallel to an incident end 22a of a light pipe 22, the semiconductor light-emitting elements 21a to 21c are arranged within a plane in line with the incident end 22a in a matrix array.

The semiconductor light-emitting elements 21a to 21c are implemented as LDs or LEDs, and thus have limitations in increasing outputs thereof. For this reason, as shown in FIG. 5, when the plurality of semiconductor light-emitting elements 21a to 21c are disposed in the matrix array, the intensity of near-infrared light rays having the respective wavelengths (λ1, λ2, and λ3) can be increased. In this way, even when the plurality of semiconductor light-emitting elements 21a to 21c arranged in the matrix array are used, the size of the incident end 22a of the light pipe 22 is not greatly changed, and an effect of the uniform intensity distribution depending on the light pipe 22 can be sufficiently obtained.

While the infrared analysis apparatus in accordance with the preferred embodiment of the present invention has been described, the present invention is not interpreted as being limited to the preferred embodiment, and can be freely modified within a scope of the present invention. For example, in the preferred embodiment, the shape of the light pipe 22 has been described as the quadrangular ring shape (hollow quadrangular cone shape) or the tetragonal frustum shape (quadrangular cone shape), but it may be a hexagonal ring shape or a hexagonal column shape, or an octagonal ring shape or an octagonal column shape. That is, the shape of the light pipe may be a polyhedral ring shape of a polyhedral column shape exceeding a triangular ring shape or a triangular column shape. Further, the shape of the light pipe may be a column shape, and need not be a tapered shape.

Further, in the preferred embodiment described above, the light pipe 22 formed by bonding the oblique sides of the four planar members B1 to B4 together (see FIG. 3A), and the light pipe 22 formed of the glass material transparent to the near-infrared light in the tetragonal frustum shape (quadrangular cone shape) have been described by way of example (see FIG. 3B). However, the inner surface or the faces of the light pipe 22 (reflective surface for the near-infrared light) are not essentially flat, but may be curved as needed.

As used herein, the following directional terms “forward, rearward, above, downward, vertical, horizontal, below, transverse, row and column” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An infrared analysis apparatus comprising a first head and a second head, wherein
the first head comprises:
a plurality of light sources each of which irradiates rays of infrared light having different wavelengths on a test object; and
an optical element that is disposed between the plurality of light sources and the test object, the optical element making intensity distribution of the infrared light uniform, and
the second head comprises:
a detector that detects the infrared light transmitted through the test object.

2. The infrared analysis apparatus according to claim 1, wherein
the optical element multi-reflects each infrared light to cause the intensity distribution of the infrared light to be uniform and to cause the infrared light irradiated on the test object, and
the optical element has a polyhedral shape.

3. The infrared analysis apparatus according to claim 1, wherein
the optical element comprises an incident end on which the infrared light from the light sources is incident, and an emergent end from which the multi-reflected infrared light emerges, and
the optical element has a tapered shape in which the emergent end is larger than the incident end.

4. The infrared analysis apparatus according to claim 3, wherein the plurality of light sources are arranged in a matrix array within a plane in line with the incident end of the optical element.

5. The infrared analysis apparatus according to claim 1, wherein the optical element is a polygonal ring-shaped internal reflector in which an inner surface thereof serves as a reflective surface reflecting the infrared light emitted from the plurality of light sources.

6. The infrared analysis apparatus according to claim 1, wherein the optical element is an internal reflector in which a glass material transparent to the infrared light is formed in a polygonal column shape and each face serves as a reflective surface.

7. The infrared analysis apparatus according to claim 1, wherein the first head further comprises a light collection optical system that is disposed between the optical element and the test object and collects the infrared light emerging from the optical element on the test object.

8. An infrared analysis apparatus comprising a first head, a second head, and a frame, wherein
the first head comprises:
a plurality of light sources each of which irradiating rays of infrared light having different wavelengths on a test object; and
an optical element that is disposed between the plurality of light sources and the test object, the optical element making intensity distribution of the infrared light uniform,
the second head comprises:
detector that detects the infrared light transmitted through the test object,
the test object is sandwiched between the first and the second head in a middle of an opening of the frame,
the frame has a quadrangular ring shape having a longitudinal direction and a transverse direction, and
the frame comprises:
a first mechanism reciprocating the first head along the test object in the longitudinal direction; and
a second mechanism reciprocating the second head along the test object in the longitudinal direction.

9. The infrared analysis apparatus according to claim 8, wherein
the optical element multi-reflects the infrared light to cause the intensity distribution of the infrared light to be uniform, and causes the infrared light irradiated on the test object, and
the optical element has a polyhedral shape.

10. The infrared analysis apparatus according to claim 8, wherein the optical element comprises:
an incident end that has a quadrangular shape and on which the infrared light emitted from the plurality of light sources is incident; and
an emergent end that has a shape similar to that of the incident end and from which the infrared light undergoing multi-reflection emerges.

11. The infrared analysis apparatus according to claim 10, wherein the optical element has a tapered shape in which the emergent end is formed so as to be larger than the incident end.

12. The infrared analysis apparatus according to claim 10, wherein the incident end is disposed so as to be close to the plurality of light sources.

13. The infrared analysis apparatus according to claim 8, wherein the first head further comprises a light collection optical system that is disposed between the optical element and the test object and collects the infrared light emerging from the optical element on the test object.

14. The infrared analysis apparatus according to claim 8, wherein the plurality of light sources are arranged in a matrix array within a plane in line with the incident end of the optical element.

15. The infrared analysis apparatus according to claim 8, wherein the optical element is a polygonal ring-shaped internal reflector in which an inner surface thereof serves as a reflective surface reflecting the infrared light emitted from the plurality of light sources.

16. The infrared analysis apparatus according to claim 8, wherein the optical element is an internal reflector in which a glass material transparent to the infrared light is formed in a polygonal column shape and each face serves as a reflective surface.

17. An infrared analysis method comprising:
irradiating a plurality of rays of infrared light having different wavelengths on a test object;
multi-reflecting the plurality of rays of infrared light to cause intensity distribution of the infrared light irradiated on the test object to be uniform; and
detecting the rays of infrared light transmitted through the test object.

18. The infrared analysis method according to claim 17, further comprising collecting the plurality of rays of infrared light on the test object.
